(19) United States
(12) Patent Application Publication
(10) Pub. No.: US 2003/0155465 A1
(43) Pub. Date: Aug. 21, 2003

(54) Flying machine using umbrella-type devices

(76) Inventors: David D. Muresan, Seattle, WA (US); David Muresan, Seattle, WA (US)

Correspondence Address: David D. Muresan, 18204 30th Ave. NE, Seattle, WA, 98155, US

(21) Appl. No.: 10/078,569

(22) Filed: Feb. 19, 2002

(51) Int. Cl. B64C 39/00

(52) U.S. Cl. 244/71

(57) ABSTRACT

This invention describes a new method for flying in the air or moving in the water. The flying machine comprises of two or more umbrellas that move vertically on a shaft in a sequential manner and are powered by an external force. Each umbrella has a blade surface composed of blades which can be closed or opened. Each umbrella also has a lateral surface connected with its blade surface. The blade surfaces of each umbrella can be circular or rectangular.

### BACKGROUND OF THE INVENTION

This invention describes a new method for flying in the air or moving in the water. There are currently two classes of flying machines. The first one is propeller based and the second one is jet propulsion based.

In the propeller class the rotary motion of the propeller-blades pushes the air from the front of the propeller to the back of the propeller. This generates a force on the propeller machine which is opposite to the direction of the flow of air caused by the rotating propellers. The faster the propeller-blades rotate, the higher is the force on the propeller machine. In helicopters, the propeller blades push the air from top to bottom causing the helicopter to lift. In propeller based airplanes, the propeller generates the forward moving force, while the wings generate the lift.

In the jet propulsion class, heat forces air, or other gas, quickly out of the jet engine causing the jet propulsion machine to move in the direction opposite to the direction of the forced gas. In a rocket, the jet engine pushes the gas towards the ground causing the rocket to move in the up direction. In jet propulsion airplanes, the jet engine generates the forward moving force, while the wings generate the lift.

Patents pertaining to other flying machines are: U.S. Pat. No. 3,801,047 which describes a rotary wing aircraft capable of omni-directional flight, U.S. Pat. No. 4,081,155 describing a man powered flying machine, U.S. Pat. No. 4,566,699 describing a flying saucer type device, U.S. Pat. No. 5,873,545 which describes a combined flying machine resembling a modified helicopter, and U.S. Pat. No. 6,007,021 describing another flying apparatus where the lifting force generating units are being arranged parallel to the plane of symmetry of the body and turnable in a vertical plane.

The main disadvantages of the propeller based, jet propulsion based and all of the above mentioned flying machines are the reduced efficiency at low speeds and/or the excessive noise.

### BRIEF SUMMARY OF THE INVENTION

The object of this invention is a new method for flying in the air or moving through the water.

Two or more umbrella-type devices, of FIG. 4, are used to push the air in one direction. This generates a force on the flying machine in the opposite direction. If the flying machine pushes the air from top to bottom, with enough force, the flying machine will lift.

The umbrella contains a blade surface having oscillating blades, which can change their position by 90 degrees as in FIG. 5, FIG. 6 and FIG. 7. In their vertical (or open) position, they allow the air to pass through. In their horizontal (or closed) position the blades touch each other closing the blade surface and allowing no air to pass through.

When the umbrella is pushed down the blades are in the closed position and no air is allowed to pass through the umbrella. This forces the air under the umbrella to be pushed down, generating an upward force on the flying machine. When the umbrella is traveling in the upward direction, the blades are in the open position and air can pass through the umbrella freely. When the umbrella is moving in the upward direction (the blades are in the open position) the umbrella does not push any significant amount of air and thus there is no significant downward force, generated by the upward moving umbrella, on the flying machine. As long as one umbrella is moving in the downward direction there will be an upward lifting force on the flying machine.

The flying machine contains two or more umbrellas. When the flying machine contains only two umbrellas, umbrella one moves in the upward direction, while umbrella two moves in the downward direction as shown in FIG. 2. When umbrella one reaches the highest point of the flying machine shaft, umbrella two reaches the lowest point of the shaft and the directions of the two umbrellas change as in FIG. 3. Umbrella one is now traveling in the downward direction, while umbrella two is traveling in the upward direction. This sequence of events repeats over and over. When using only two umbrellas we say that the umbrellas are 180 degrees apart.

With only two umbrellas, the flying machine may have moments with no significant upward (or lifting) force. This happens when the two umbrellas are changing directions.

An umbrella-type device with three umbrellas, as shown in FIG. 1, working at 120 degrees apart will always have at least one umbrella moving in the downward direction, thus always providing a lifting force on the flying machine. To move the machine horizontally, at least one of the downward moving umbrella must be inclined in the direction we wish to move horizontally.

This invention eliminates the disadvantage of propeller or reaction engine, having a higher efficiency and reduced noise. The efficiency could be so high that even human force might be sufficient for powering the flying machine.

### BRIEF DESCRIPTION OF THE DRAWINGS

FIG. 1 shows the machine with three umbrellas.

FIG. 2 shows the flying machine with two umbrellas. The figure depicts the flying machine in the first half of one flying cycle.

FIG. 3 shows the flying machine with two umbrellas. The figure depicts the flying machine in the second half of one flying cycle.

FIG. 4 shows the details of one circle-type umbrella.

FIG. 5a shows profile view of the umbrella blades in their open position.

FIG. 5b shows profile view of the umbrella blades in their closed position.

FIG. 6a shows side view of the rectangular-type umbrella blades in their open position.

FIG. 6b shows side view of the rectangular-type umbrella blades in their closed position.

FIG. 7a shows side view of the circle-type umbrella blades in their open position.

FIG. 7b shows side view of the circle-type umbrella blades in their closed position.

### DETAILED DESCRIPTION OF THE INVENTION

The flying machine flies by employing at least two specially designed umbrellas.

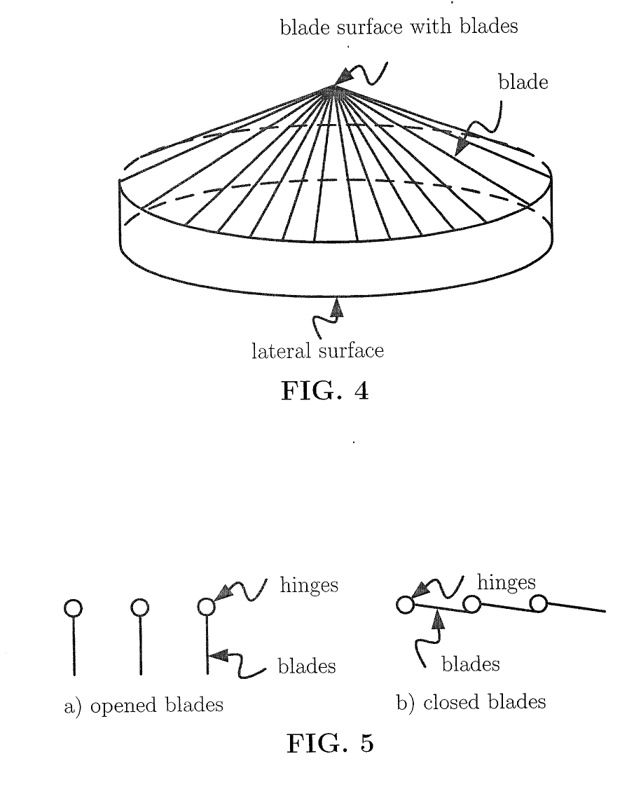

First, the specially designed umbrella is depicted in FIG. 4. The key components of the umbrella are:

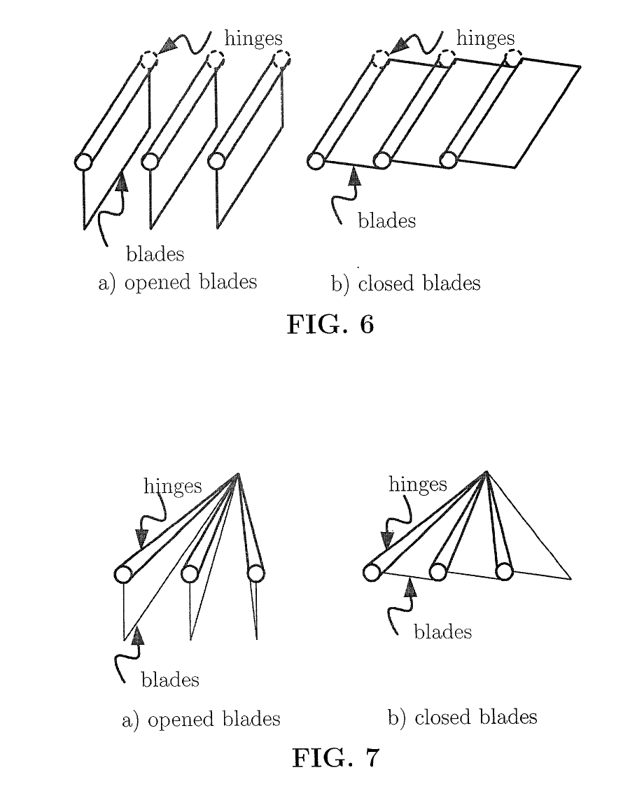

1. A blade surface comprised of blades that can be either opened, as shown in FIG. 5a, FIG. 6a and FIG. 7a, or closed as shown in FIG. 5b, FIG. 6b and FIG. 7b. (FIG. 5 is a profile view of the blades, FIG. 6 is a side view of the blades in a rectangular-type umbrella and FIG. 7 is a side view of the blades on the circle-type umbrella.) The open or closed position of the blades is dictated by the movement of the air or controlled mechanically, and it depends on the direction of the umbrella movement. When the umbrella moves down the blades are in the closed position and we say that the umbrella is closed. When the umbrella moves up the blades are in the open position and we say that the umbrella is opened.

2. A solid lateral surface at the edge of the blade surface. Its purpose is to prevent the air from escaping the closed umbrella when the umbrella is moving down.

Second, the flying machine using two umbrellas works as follows:

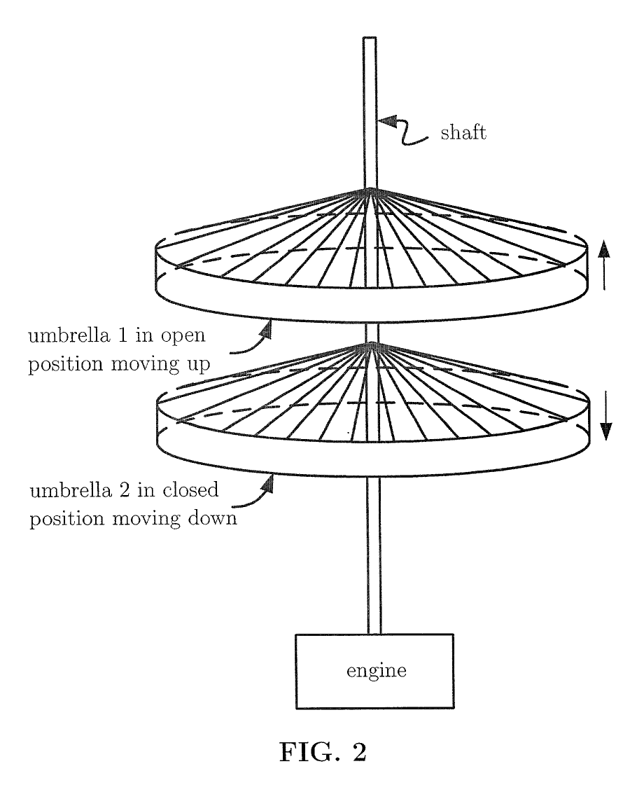

1. The first half of the flying cycle is depicted in FIG. 2. Umbrella one is opened and moving upwards. Umbrella two is closed and moving downwards. Umbrella one being opened generates no significant downward force while umbrella two being closed generates a significant amount of upward force, or lift, on the flying machine.

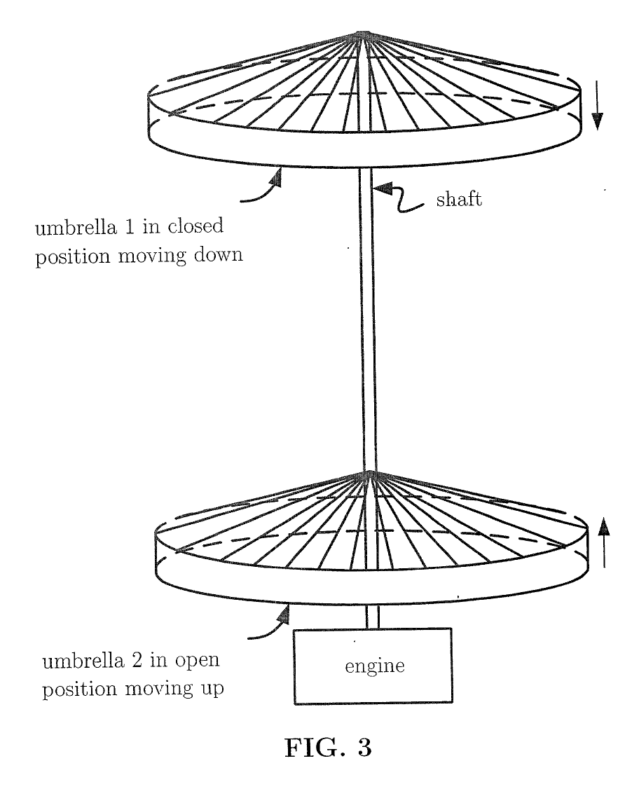

2. When umbrella one reaches the top of the shaft, umbrella two reaches the bottom of the shaft and the first half of the cycle is finished. The second half of the cycle begins. This is depicted in FIG. 3. In the second half of the cycle umbrella one is closed and moving down, while umbrella two is opened and moving up. This time umbrella one provides the lift, while umbrella two does not generate any significant downward force.

3. Once in the air, to fly the flying machine in any one particular direction, one of the downward moving umbrellas must be tilted in the desired direction.

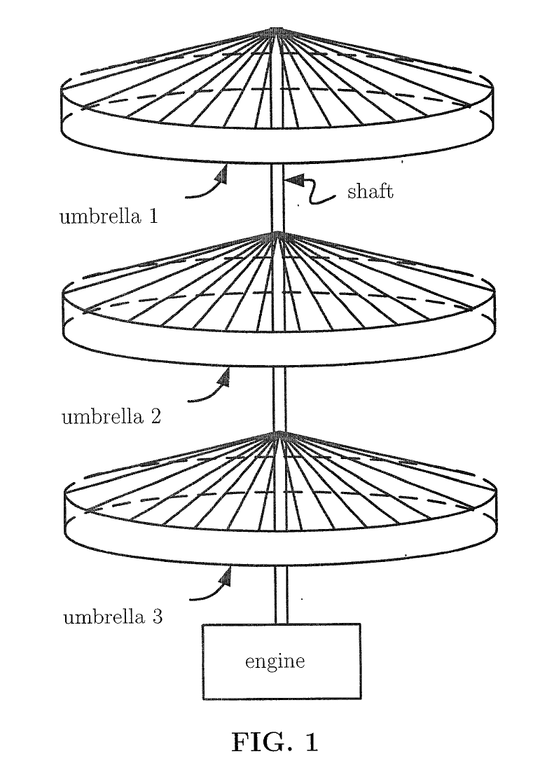

Finally, in FIG. 1 we have a flying machine showing three umbrellas.

we claim:

1. A flying machine comprising
two or more umbrellas that move vertically on a shaft, in a sequential manner and powered by an external force;
each said umbrella being circular or rectangular and having a surface composed of blades which are closed or open;
each said umbrella containing a lateral surface connected with the blade surface of the umbrella.
